(19) United States
(12) Patent Application Publication
(10) Pub. No.: US 2014/0059971 A1
(43) Pub. Date: Mar. 6, 2014

(54) THERMAL INSULATION MATERIALS

(71) Applicants: Bjørn Petter Jelle, Trondheim (NO); Bente Gilbu Tilset, Hvalstad (NO); Susie Jahren, Olso (NO); Arild Gustavsen, Throndheim (NO); Tao Gao, Trondheim (NO)

(72) Inventors: Bjørn Petter Jelle, Trondheim (NO); Bente Gilbu Tilset, Hvalstad (NO); Susie Jahren, Olso (NO); Arild Gustavsen, Throndheim (NO); Tao Gao, Trondheim (NO)

(21) Appl. No.: 14/005,919

(22) PCT Filed: Mar. 19, 2012
(86) PCT No.: PCT/NO2012/050045

§ 371 Date: Nov. 18, 2013

(30) Foreign Application Priority Data
Mar. 18, 2011 (US) 61454031

(51) Int. Cl. E04B 1/76; B28B 11/00

(52) U.S. Cl. CPC E04B 1/76; B28B 11/00
USPC 52/741.4; 423/579; 423/592.1; 423/335; 423/610; 423/625; 423/622; 423/632; 423/605; 264/117; 264/632

(57) ABSTRACT

The present invention relates to thermal insulation materials made of hollow oxide particles. Use of hollow oxide particles having an overall thermal conductivity of less than 0.026 W/(mK) is for example suitable for the building sector or other areas where thermal insulation is required.

### TECHNICAL FIELD

Present invention relates to thermal insulation materials made of hollow oxide particles, the preparation thereof and their use as thermal insulation materials.

### BACKGROUND/PRIOR ART

The demand to improve energy efficiency of buildings is increasing as the energy use in the building sector accounts for a significant part of the world's total energy use and greenhouse gas emissions. In this respect the thermal insulation of buildings plays an important role, where one major objective is to develop new and robust insulation materials and solutions with as low thermal conductivity values as possible. Applying traditional thermal insulation materials requires ever increasing thicker building envelopes. This is not desirable for several reasons, e.g. space issues with respect to economy and floor area, transport volumes, architectural restrictions and other limitations, material usage and existing building techniques.

State-of-the-art thermal insulation materials and solutions like vacuum insulation panels (VIP) [2-3] and aerogels [4] may represent the best thermal insulation today with respect to very low thermal conductivity values. However, both VIPs and aerogels have their drawbacks. The VIP solution, which attains a considerably lower thermal conductivity than the aerogels, does not represent a robust solution as air and moisture over time will penetrate the VIP envelope and thus increase the thermal conductivity due to loss of vacuum. Adaption and cutting of VIPs at the building site cannot be performed without loss of vacuum and thermal resistance, and any perforation of the VIP envelope increases the thermal conductivity from the pristine non-aged value of typical 4 mW/(mK) to about 20 mW/(mK). Furthermore, both VIPs and aerogels are very costly solutions compared to traditional thermal insulation. Nevertheless, in areas with a high living area market value per square meter, a reduced wall thickness (e.g. by use of VIPs) may involve large area savings and thus a higher value of the real estate.

Other high performance thermal insulation materials i.e. advanced insulation materials (AIM) include vacuum insulation materials (VIM), gas insulation materials (GIM), nano insulation materials (NIM), dynamic insulation materials (DIM) and NanoCon have been presented earlier [2, 5-7].

The total overall thermal conductivity λₜₒₜ, i.e. the thickness of a material divided by its thermal resistance, is in principle made up from several contributions:

λₜₒₜ=λ_{solid}+λ_{gas}+λ_{rad}+λ_{conv}+λ_{coupling}+λₗₑₐₖ (1)

where λₜₒₜ=total overall thermal conductivity, λ_{solid}=solid state thermal conductivity, λ_{gas}=gas thermal conductivity, λ_{rad}=radiation thermal conductivity, λ_{conv}=convection thermal conductivity, λ_{coupling}=thermal conductivity term accounting for second order effects between the various thermal conductivities in Eq.1 and λₗₑₐₖ=leakage thermal conductivity. Each of these thermal contributions must be minimized in order to reach as low thermal conductivity as possible. The leakage thermal conductivity λₗₑₐₖ representing an air and moisture leakage driven by a pressure difference, is normally not taken into consideration since insulation materials and solutions are supposed to be without any holes that would enable such a thermal leakage transport. The coupling term λ_{coupling} can be included to account for second order effects between the various thermal conductivities in Eq.1, and may be quite complex. Theoretical approaches to thermal performance of vacuum insulation panels (VIP) usually assume this coupling effect to be negligible [8]. Generally, another coupling term might also be included in Eq.1, i.e. the interaction between the gas molecules and the solid state pore walls. However, as we will see later this last coupling term is included through a factor in the expression for the gas conductivity as given in Eq.2 for the Knudsen effect. The solid state thermal conductivity λ_{solid} is related to thermal transport between atoms by lattice vibrations, i.e. through chemical bonds between atoms. The gas thermal conductivity λ_{gas} arises from gas molecules colliding with each other and thus transferring thermal energy from one molecule to the other. The radiation thermal conductivity λ_{rad} is connected to the emittance of electromagnetic radiation in the infrared (IR) wavelength region from a material surface. The convection thermal conductivity λ_{conv} is due to thermal mass transport or movement of air and moisture. All these thermal conductivity contributions are driven by or dependent upon the temperature and temperature difference.

A vacuum insulation material (VIM) is basically a homogeneous material with a closed small pore structure filled with vacuum with an overall thermal conductivity of less than 4 mW/(mK) in pristine condition. The VIM can be cut and adapted at the building site with no loss of low thermal conductivity. Perforating the VIM with a nail or similar would only result in a local heat bridge, i.e. no loss of low thermal conductivity. A gas insulation material (GIM) is basically a homogeneous material with a closed small pore structure filled with a low-conductance gas, e.g. Ar, Kr or Xe, with an overall thermal conductivity of less than 4 mW/(mK) in the pristine condition. That is, a GIM is basically the same as a VIM, except that the vacuum inside the closed pore structure is substituted with a low-conductance gas. For further details it is referred to Jelle et al. [6].

The development from VIPs to nano insulation materials (NIM) is depicted in FIG. 1. In the NIM the pore size within the material is decreased below a certain level, i.e. 40 nm or below for air, in order to achieve an overall thermal conductivity of less than 4 mW/(mK) in the pristine condition. That is, a NIM is basically a homogeneous material with a closed or open small nano pore structure with an overall thermal conductivity of less than 4 mW/(mK) in the pristine condition. The low gas thermal conductivity in NIMs is caused by the Knudsen effect where the mean free path of the gas molecules is larger than the pore diameter. That is, a gas molecule located inside a pore will hit the pore wall and not another gas molecule. The resulting gas thermal conductivity λ_{gas} versus pore diameter and pressure for air is depicted in FIG. 1 based on the following simplified expression taking into account the Knudsen effect [2,6]:

$${λ}_{gas} = \frac{{λ}_{gas , 0}}{1 + 2 β Kn} = \frac{{λ}_{gas , 0}}{1 + \frac{\sqrt{2} β {k}_{B} T}{π {d}^{2} p δ}} , Kn = \frac{{σ}_{mean}}{δ} = \frac{{k}_{B} T}{\sqrt{2} π {d}^{2} p δ} \qquad ( 2 )$$

where λ_{gas}=gas thermal conductivity in the pores (W/(mK)), λ_{gas, 0}=gas thermal conductivity in the pores at STP (standard temperature and pressure) (W/(mK)), β=coefficient characterizing the molecule-wall collision energy transfer efficiency (between 1.5-2.0), k_{B}=Boltzmann's constant≈1.38·10⁻²³ J/K, T=temperature (K), d=gas molecule collision diameter (m), p=gas pressure in pores (Pa), δ=characteristic pore diameter (m) and σₘₑₐₙ=mean free path of gas molecules (m). The radiation and solid state lattice conductivity in the NIMs has to be kept as low as possible in order to obtain the lowest possible overall thermal conductivity. Applying the Stefan-Boltzmann relationship it may be shown that the radiation thermal conductivity decreases linearly with decreasing pore diameter, where the emissivity of the inner pore walls determine the slope of the decrease, according to the following relationship [6]:

$${λ}_{rad} = \frac{{π}^{2} {k}_{B}^{4} δ}{60 {ℏ}^{3} {c}^{2} [ \frac{2}{ɛ} - 1 ]} \frac{( {T}_{i}^{4} - {T}_{e}^{4} )}{( {T}_{i} - {T}_{e} )} \qquad ( 3 )$$

where λ_{rad}=radiation thermal conductivity in the pores (W/(mK)), σ=π²k_{B}⁴/(60,³c²)=Stefan-Boltzmann's constant≈5.67·10⁻⁸ W/(m²K⁴), k_{B}=Boltzmann's constant≈1.38·10⁻²³ J/K, =h/(2π)≈1.05·10⁻³⁴ Js=reduced Planck's constant (h=Planck's constant), c=velocity of light≈3.00·10⁸ m/s, δ=pore diameter (m), ε=emissivity of inner pore walls (assumed all identical), Tᵢ=interior (indoor) temperature (K) and Tₑ=exterior (outdoor) temperature (K). That is, the smaller the pores, and the lower the emissivity, the lower the radiation thermal conductivity will be FIG. 2.

However, various works [9-11] describe a large increase in the thermal radiation as the pore diameter decreases below the wavelength of the thermal (infrared) radiation (e.g. 10 μm), where tunneling of evanescent waves may play an important role. Note that in FIG. 2 the radiation thermal conductivity is only plotted down to a pore diameter of 0.1 mm (100 μm), which is about 10 times larger than the mean infrared wavelength at room temperature (10 μm). The work by Mulet et al. [9] and Joulain et al. [10] indicate that the large thermal radiation is only centered around a specific wavelength (or a few). That is, this might suggest that the total thermal radiation integrated over all wavelengths is not that large. The work by Jelle et al. [6] elaborates more on these thermal radiation issues. These topics are currently being addressed in on-going research activities.

A dynamic insulation material (DIM) is a material where the thermal conductivity can be controlled within a desirable range. The thermal conductivity control may be achieved by being able to change in a controlled manner (a) the inner pore gas content or concentration including the mean free path of the gas molecules and the gas-surface interaction, (b) the emissivity of the inner surfaces of the pores and (c) the solid state thermal conductivity of the lattice. Two models exist for describing solid state thermal conductivity. That is, the phonon thermal conductivity, i.e. atom lattice vibrations, and the free electron thermal conductivity. One might ask if it could be possible to dynamically change the thermal conductivity from very low to very high, i.e. making a DIM? Furthermore, could other fields of science and technology inspire and give ideas about how to be able to make DIMs, e.g. from the fields of electrochromic materials, quantum mechanics, electrical superconductivity or others? The thermal insulation regulating abilities of DIMs give these conceptual materials a great potential. It is referred to Jelle et al. [6] for further details and elaborations concerning DIMs. With decreasing thermal conductivities of insulation materials, new solutions should also be sought for the load-bearing elements of the building envelope. Using concrete as an example, one might envision mixing NIMs into the concrete, thereby decreasing the thermal conductivity of the construction material substantially, while maintaining most or a major part of the mechanical strength and load-bearing capabilities of concrete. Hence, a new material is introduced on a conceptual basis (Jelle et al. [7]): NanoCon is basically a homogeneous material with a closed or open small nano pore structure with an overall thermal conductivity of less than 4 mW/(mK) (or another low value to be determined) and exhibits the crucial construction properties that are as good as or better than concrete. In the above definition of NanoCon, a homogeneous material is stated, although the first attempts to reach such a material might be tried by piecing or mixing several different materials together, i.e. with a final material product which on a nanoscale is not homogeneous. For example, joining NIM and carbon nanotubes in one single material might enable a very low thermal conductivity due to the NIM part and a very large tensile strength due to the carbon nanotube part. In this respect it should be noted that the extremely large tensile strength of carbon nanotubes (63 000 MPa measured and 300 000 MPa theoretical limit) surpasses that of steel rebars (500 MPa) by more than two orders. As a comparison, concrete itself (without rebars) has a tensile strength of 3 MPa and a compressive strength of 30 MPa.

The current materials that most closely resemble these ideal nano insulation materials are silica-based aerogels, which are commercially available as nanoporous materials with an open pore structure. Their thermal conductivity in air is typically around 13 mW/(mK) due to the Knudsen effect. They are used as core material in VIPs (4 mW/(mK)), contained in insulating blankets (14 mW/(mK)), and as loose, hydrophobic granules for spraying into building crevices (17 mW/(mK)). A very interesting aspect with aerogels is that they can be produced as either opaque, translucent or transparent materials, thus enabling a wide range of possible building applications. Aerogels have relatively high compression strength, but are very fragile due to their very low tensile strength, and are easily broken down by abrasion processes. The aim is to develop new thermal insulation materials with even better properties than aerogels. The main target is lowered thermal conductivity, with improved mechanical properties. In the first attempts, the aim is to be able to control the nanoscale structure of the material. Silica is chosen as a model material, since various silica precursors are available and their chemistry is quite well-known. At a later stage, similar methods may be developed for other materials, e.g. titania and alumina.

CN101585954A describes a composite material consisting of silicon dioxide hollow spheres and polymers suitable as insulating material comprising a polymer substrate and submicron mono-disperse silicon dioxide hollow spheres without agglomerations uniformly distributed in the substrate, where the polymer substrate is a substrate of epoxy, polyurethane or polyethylene glycol terephthalate. The hollow inner diameter of the submicron silicon dioxide hollow sphere is 100-172 nm; the thickness of outer wall is 50-100 nm; the submicron silicon dioxide hollow sphere is 1-35 wt. % of polymer substrate in terms of weight.

Short summary of the invention

The invention relates to porous insulation materials made of hollow oxide particles. The hollow particles have a typical inner diameter of 10-1000 nm and a dense or porous shell/wall with a typical thickness of less than 50 nm. The shell/wall may be a single phase material or a composite material. Preferably the oxide particles are metal oxide particles or hollow semi-metal oxide particles. In one embodiment the hollow oxide particles are made of at least one oxide selected from the group consisting of silica, titania, alumina, zinc oxide, iron oxide and manganese oxide. The hollow nanoparticles may be spherical, cubic, elliptical, or tube-like, and are preferably hydrophobic. The overall thermal conductivity of the porous nano insulation materials is less than that of normal air, e.g., 0.026 W/(mK). To prepare the hollow nanoparticles, several synthetic approaches can be used, e.g., template-assistant methods, where the template can be soft or hard particles or molecular aggregations with defined geometry.

The particles can also be prepared by different methods; for example by membrane foaming or gas release. Hydrolysis and condensation of silane precursors may be used to form the solid network.

### FIGURES

FIG. 1 The development from VIPs to NIMs (left) and the effect of pore diameter and pressure on the gas thermal conductivity (Eq.2) for air (right) [6].

FIG. 2. The radiation thermal conductivity versus pore diameter for various emissivities of the inner pore walls. From Eq.3 [6].

FIG. 3. Preparation of gas capsules by membrane emulsification. Left: Aim of experiment. Right: Micron-sized capsules obtained by Yang et al. [12].

FIG. 4. Schematic diagram showing the formation mechanism of hollow silica spheres [15].

FIG. 5. SEM image (BSE) showing an overview of the nanosphere sample, where the scale bar is 2 μm.

FIG. 6. SEM image (BSE) showing an unetched sphere (left), as well as the same sphere after a little etching (middle) and after more extensive etching (right). The scale bar is 300 nm in all images.

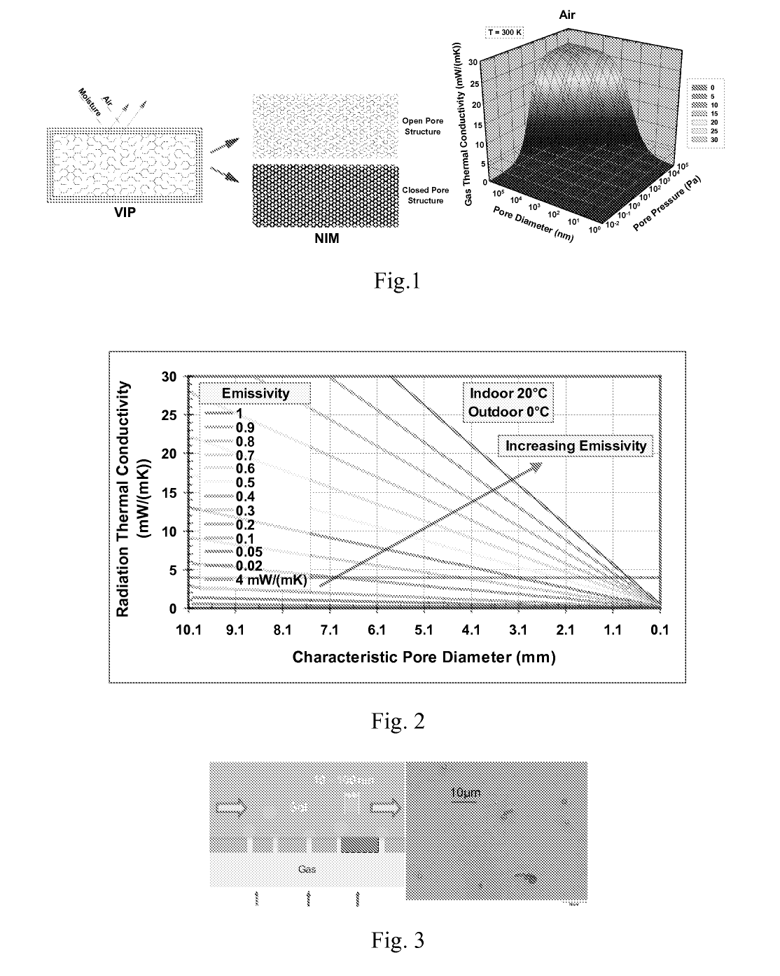

### DETAILED DESCRIPTION OF THE INVENTION

Three different methods for producing nanoporous hydrophobic materials have been investigated, i.e. membrane foaming, gas release and templating. In all cases, hydrolysis and condensation of silane precursors may be used to form the solid network. This is the same reaction that is used for production of aerogels and may be depicted as:

Hydrolysis: R′-M-OR+H—OH→R′-M-OH+ROH (4)

Condensation: R′-M-OH+HO—Si—R′→R′-M-O—Si—R′+H₂O (5)

R′-M-OR+HO—Si—R′→R′-M-O—Si—R′+ROH (6)

Membrane Foaming

In membrane foaming, the idea is to produce foams with nanoscale bubbles, followed by condensation and hydrolysis within the bubble walls to obtain a silica nanofoam. In the process, gas is pressed through a membrane to obtain bubbles with controlled size as depicted in FIG. 3. Hydrolysis and condensation of precursors at the bubble-liquid interface should result in formation of gas capsules. This method was previously used to obtain nitrogen-containing capsules with titania-polypyrrole composite shells. Their diameter was in the range 1-5 μm as shown in FIG. 3. Initial experiments indicated that preparation of silica nanofoams might be difficult to accomplish. This was supported by theoretical considerations. The gas pressure must be very accurately adjusted; if the pressure is too low, no bubbles will be formed and if it is too high, a continuous gas stream will result. The size of the bubbles may be decreased by decreasing the pore size of the membrane and adjusting its surface properties to obtain a high contact angle with the solvent, i.e. the solvent should be repelled from its surface. Furthermore, the solvent density should be rather high and its surface tension low. It should in principle be possible to design a reaction system that fulfills these requirements, so that production of nanosized bubbles is viable.

For the production of a solid nanofoam, the liquid foam must be stable long enough for the reactions in Eqs.4-6 to proceed. Furthermore, if the foam is to be of interest as an insulator, its walls must be thin. Otherwise, the solid contribution to the overall thermal conductivity will be too high. Wall thicknesses of about 20 nm may be achieved if surfactant bilayers are used to stabilize the walls and the applied solvent has low viscosity and is rapidly drained from the wall interior. It is possible to achieve this in water-based systems. However, the reactions in Eqs.4-6 are generally performed in alcohol solutions like ethanol or isopropanol. No surfactant was found that could stabilize nanofoams long enough, thus this line of work was so far abandoned.

### Gas Release

The gas release method would require simultaneous formation of nanosized gas bubbles throughout the reaction system, followed by hydrolysis and condensation (Eqs.4-6) to form a solid at the bubble perimeter. Bubble formation could be achieved by either evaporation or decomposition of a component in the system. This method is similar to the process described by Grader et al. [13], where crystals of AlCl₃(Prⁱ₂O) were heated to produce foams with closed cell structures. In this case, the crystals themselves decomposed. Upon further heating, the remaining solid dissolved in the generated solvent. Then a polymerization reaction occurred at the temperature of solvent evaporation. The solvent bubbles were trapped within the polymerizing gel, forming stable foam with pore sizes 50-300 μm after completion of the reaction. The gas release process entails several challenges. To obtain nanosized bubbles with a sufficiently narrow size distribution, the temperature must be the same throughout the liquid phase. In ordinary reaction conditions, this would be difficult to achieve. Further, the reaction to form the solid shell must proceed very rapidly if the shell is to be formed before the bubbles grow too large. This would require very reactive chemicals, and their application would require strict control of humidity both in the working environment and in the solvents used.

Templatinq

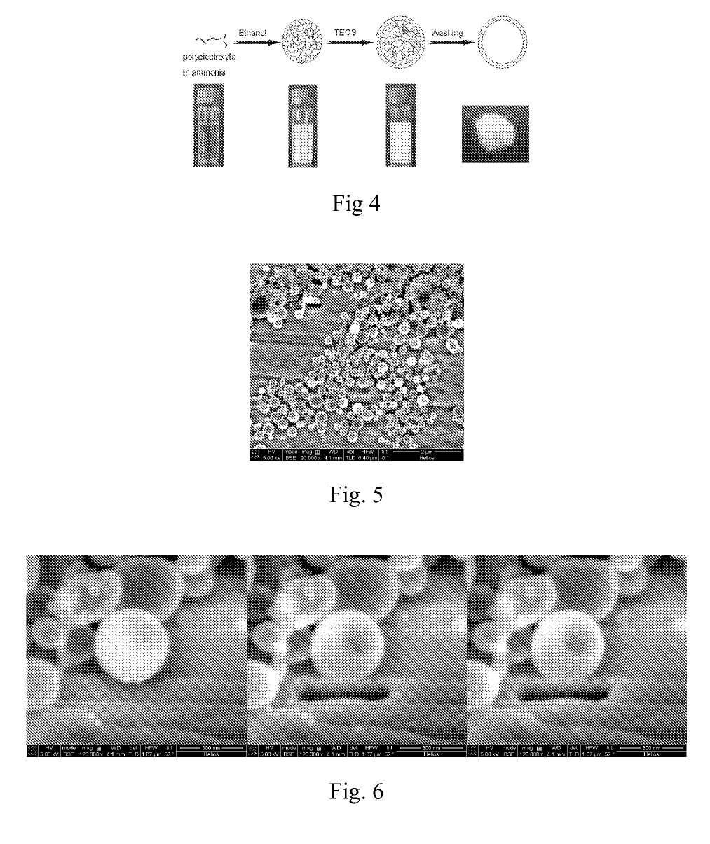

In the templating process, a nanoscale structure in the form of a nanoemulsion or polymer gel is prepared, followed by hydrolysis and condensation by Eqs.4-6 to form a solid. This procedure is used for preparing e.g. catalysts and membrane materials. The approach is to prepare hollow silica nanospheres, followed by condensation and sintering to form macroscale particles or objects. For thermal insulation materials, small pore size is preferred, combined with a small wall thickness. Assuming a pore diameter of 100 nm and a wall thickness of 15 nm, the solid volume fraction of the particle would be 54%. With cubic close packing (ccp) of monosized spheres, the solid fraction of a “nanosphere compact” would be 41%. In practice, the sphere packing will always be less efficient than ccp, thus lower solid fractions are envisaged—as is also desired. Several methods for nanosphere production are given in the literature. The current work is based on the work reported by Du et al. [14], who used the method for preparing antireflection coatings. The method is described in more detail by Wan and Yu [15], and their schematic depiction of the synthesis process is shown in FIG. 4.

Synthesis starts with dissolving the polyelectrolyte polyacrylic acid (PAA) in ammonia, followed by addition of ethanol to form an emulsion. The droplet size in the emulsion increases with increasing concentration of polyelectrolyte in the solution. The next step is gradual addition of tetraethoxysilane (TEOS), which reacts with water at the droplet surface and forms a solid silica shell. When the sample is washed with water, the polyelectrolyte diffuses through the shell, and after drying, hollow silica nanospheres are obtained.

Experimental Details of Templating Process

An initial templating experiment was conducted. First, 0.27 ml of PAA (polyacrylic acid, MW˜5 000, 50% aqueous solution, Polysciences) was dissolved in 4.5 ml 25% NH₄OH solution (Merck). An emulsion was formed by adding 90 ml of absolute ethanol (Kemetyl) was added during magnetic stirring at a rate of 760 rpm. TEOS (tetraethoxysilane, purum 98.0%), Fluka) was added in five 0.45 ml portions, with at least one hour between additions. The total time of addition was 22 h. The sample was diluted with water to twice the volume and centrifuged at 10 000 rpm for 10 min. The supernatant was removed and the particles were redispersed in water. This cleaning procedure was performed four times. The particle size of the nanospheres in water was measured using a Malvern Zetasizer Nano ZS. The particles were dried and investigated by scanning electron microscopy (SEM), using backscattered electrons (BSE) in a Helios Nanolab” instrument. To further determine whether the spheres were hollow, they were subjected to focused ion beam (FIB) cutting.

Initial Nanosphere Manufacturing Results

The produced spheres had a reasonably narrow size distribution, with an average particle size of 190 nm measured by the Malvern Zetasizer. SEM images showed that most particles had diameters between 90 and 400 nm, with most around 200 nm (FIG. 5), which is well in agreement with the size measured in water. In FIG. 5 the spheres show up as circles with dark centers and light edges. This is due to the atomic contrast in BSE images. SiO₂ is shown lighter than void areas. If the particles were dense SiO₂ spheres, they would also have light centers. Thus, this image is the first indication that most of the spheres are indeed hollow. Images of separate particles before and after FIB etching are shown in FIG. 6. For convenience, relatively large spheres were chosen for the FIB experiments. It is clearly seen that the ion beam removes material from the sphere surface, showing an empty interior. Eventually, the sphere is slightly deformed. If the walls of the sphere are thin, the sphere collapses after etching. The rectangular hole in front of the particle in FIG. 6 (middle and right photos) is a result of ion beam etching of the sample holder.

The thermal insulation material according to the invention comprises hollow particles. The inner diameter size of the hollow particles will typically be in the range 10-1000 nm, 20-400 nm, 20-300 nm, 20-200 nm or 20-100 nm. The dense or porous shell/wall will have a typical thickness of less than 50 nm. The aim is to produce hollow particles with as small wall thicknesses as possible, but avoid collapsing of the particles. For use as thermal insulation the overall thermal conductivity of the porous nano insulation materials should be less than that of normal air, e.g., 0.026 W/(mK), preferably less than 4 mW/(mK). The particles are filled with gas, they are preferably filled with air.

In one embodiment of the invention, the shell of the hollow particles consists essentially of inorganic oxide material. In other embodiments the shell consists essentially of a metal oxide or a semi-metal oxide. The shell may be a single phase material or a composite consisting of silica, titania, alumina, zinc oxide, iron oxide, manganese oxide, etc. Any type of oxide that can be prepared from soluble alkoxy compounds can be used. The hollow particles may be spherical, cubic, elliptical, or tube-like.

The hollow oxide particles used for thermal insulation can be used without any further treatment. In one embodiment of the invention hollow spherical particles of silica are prepared and used as heat insulation material.

In order to make the nanospheres stick together to form a macroscale material with low solid content different methods should be further investigated. In one embodiment the particles are preferably made hydrophobic, by a hydrophobic surface treatment.

### REFERENCES

[1] McKinsey, “Pathways to a low-carbon economy. Version 2 of the global greenhouse gas abatement cost curve”, McKinsey & Company, 2009.

[2] R. Baetens, B. P. Jelle, J. V. Thue, M. J. Tenpierik, S. Grynning, S. Uvsløkk and A. Gustaysen, “Vacuum insulation panels for building applications: A review and beyond”, Energy and Buildings, 42, 147-172, 2010.

[3] M. J. Tenpierik, “Vacuum insulation panels applied in building constructions (VIP ABC)”, Ph.D. Thesis, Delft University of Technology (Delft, The Netherlands), 2009.

[4] R. Baetens, B. P. Jelle and A. Gustaysen, “Aerogel insulation for building applications: A state-of-the-art review”, Energy and Buildings, 43, 761-769, 2011.

[5] B. P. Jelle, A. Gustaysen and R. Baetens, “Beyond vacuum insulation panels—How may it be achieved?”, in Proceedings of the 9th International Vacuum Insulation Symposium (IVIS 2009), London, England, 17-18 Sep. 2009.

[6] B. P. Jelle, A. Gustaysen and R. Baetens, “The path to the high performance thermal building insulation materials and solutions of tomorrow”, Journal of Building Physics, 34, 99-123, 2010.

[7] B. P. Jelle, A. Gustaysen and R. Baetens, “The high performance thermal building insulation materials and solutions of tomorrow”, Proceedings of the Thermal Performance of the Exterior Envelopes of Whole Buildings XI International Conference, Clearwater Beach, Fla., U.S.A., 5-9 Dec. 2010.

[8] U. Heinemann, “Influence of water on the total heat transfer in ‘evacuated’ insulations”, International Journal of Thermophysics, 29, 735-749, 2008.

[9] J.-P. Mulet, K. Joulain, R. Carminati and J.-J. Greffet, “Enhanced radiative heat transfer at nanometric distances”, Microscale Thermophysical Engineering, 6, 209-222, 2002.

[10] K. Joulain, J.-P. Mulet, F. Marquier, R. Carminati and J.-J. Greffet, “Surface electromagnetic waves thermally excited: Radiative heat transfer, coherence properties and Casimir forces revisited in the near field”, Surface Science Reports, 57, 59-112, 2005.

[11] Z. M. Zhang, “Nano/microscale heat transfer”, McGraw-Hill, 2007.

[12] J. Yang, L. Sivakanesar and C. R. Simon, “Membrane emulsification for preparation of gas capsules”, Personal communication, 2007.

[13] G. S. Grader, Y. de Hazan and G. E. Shter, “Ultra light ceramic foams”, Sol-gel Synthesis and Processing, 95, 161-172,1998.

[14] Y. Du, L. E. Luna, W. S. Tan, M. F. Rubner and R. E. Cohen, “Hollow silica nanoparticles in UV-visible antireflection coatings for poly(methyl methacrylate) substrates”, ACS Nano, 4, 4308-4316, 2010.

[15] Y. Wan and S.-H. Yu, “Polyelectrolyte controlled large-scale synthesis of hollow silica spheres with tunable sizes and wall thicknesses”, Journal of Physical Chemistry C, 112, 3641-3647, 2008.

1-21. (canceled)

22. Thermal insulation material with controlled nanoscale structure, comprising hollow oxide particles stuck together to form a material with a low solid content and to lower the gas thermal conductivity due to the Knudsen effect, wherein the overall thermal conductivity is less than 0.026 W/(m K).

23. Thermal insulation material according to claim 22, wherein the hollow oxide particles are filled with a gas and have an inner diameter in a range 10 to 1000 nm.

24. Thermal insulation material according to claim 23, wherein the inner diameter is in the range 20 to 400 nm.

25. Thermal insulation material according claim 22, wherein the hollow oxide particles have a dense or porous shell with a thickness less than 50 nm.

26. Thermal insulation material according to claim 25, wherein the shell is made of a metal oxide or semi-metal oxide.

27. Thermal insulation material according to claim 26, wherein the shell is made of at least one oxide selected from the group consisting of silica, titania, alumina, zinc oxide, iron oxide and manganese oxide.

28. Thermal insulation material according to claim 22, wherein the hollow oxide particles have a shape selected from spherical, cubic, elliptical or tube-like.

29. Thermal insulation material according to claim 22, wherein the hollow oxide particles are surface treated.

30. Method for insulating a building, comprising installing into the building the thermal insulation material according to claim 22.

31. Method for preparing the thermal insulation material according to claim 22, comprising assembling hollow oxide particles to form macroscale particles or objects.

32. Method according to claim 31, wherein the macroscale particles or objects are formed by a process selected from hydrolysis and condensation, chemical treatment or sintering.
